(19) United States
(12) Patent Application Publication
(10) Pub. No.: US 2005/0098196 A1
(43) Pub. Date: May 12, 2005

(54) Relocatable pressure washer adapter

(75) Inventor: Paul Hebert, Broussard, LA (US)

Correspondence Address: CONLEY ROSE, P.C., P. O. BOX 3267, HOUSTON, TX, 77253-3267, US

(73) Assignee: M-I L.L.C., Houston, TX (US)

(21) Appl. No.: 10/444,149

(22) Filed: May 22, 2003

Related U.S. Application Data
(60) Provisional application No. 60/382,804, filed on May 23, 2002.

(51) Int. Cl. B08B 3/00

(52) U.S. Cl. 134/22.18; 134/34; 134/167 R; 134/177; 134/200

(57) ABSTRACT

Methods and apparatus for attaching a pressure washing device to a storage tank that allows adjustment of the location of the pressure washing device. One embodiment includes a mounting plate adapted to be connected to a tank opening, a second plate hingably attached to the mounting plate, and a pressure washer attachment plate hingably connected to the second plate. The hinged connections may be arranged such as to allow rotation about two axes that are substantially perpendicular to each other. Linear connection apparatus may also be provided to control the relative location between the plates. A roof mounted system includes a vertical extension arm that is suspended from a roof-mounted manway. The vertical extension arm supports a primary pivot point about which a first extension arm deploys. The first extension arm carries a telescoping extension arm that has a secondary pivot point about which pivots a wash head arm having a wash head mounted on the end.

### CROSS-REFERENCE TO RELATED APPLICATIONS

The present application claims priority to U.S. Provisional Application No. 60/382,804, filed May 23, 2002, titled “Relocatable Pressure Washer Adapter,” and hereby incorporated herein by reference for all purposes.

### STATEMENT REGARDING FEDERALLY SPONSORED RESEARCH OR DEVELOPMENT

Not applicable.

### BACKGROUND OF THE INVENTION

The present invention relates generally to methods and apparatus for the cleaning deposits from the interior of storage tanks. More specifically, the present invention relates to methods and apparatus for attaching a pressure washing device to a storage tank that allows for adjustment of the location of the pressure washing device. More specifically, the preferred embodiments show a light-weight and easily relocatable device that can be transported to or permanently mounted on both stationary and transportable tanks to effect the jet washing of the tank.

In many industries, large storage tanks are commonly used for the storage of liquid products. The liquids stored in such tanks may contain materials that tend to deposit and build up on the interior of the tank. It is not uncommon to have several inches of material deposited before the tank is taken out of service for cleaning.

Storage tanks that are used for storing fluids used in the drilling of hydrocarbon wells are particularly susceptible to the build up of solids within the tanks. Drilling fluids are normally very dense fluids that have a high solids content. These solids will tend to settle out of the fluid and deposit within the storage tanks. This solid material can be very thick and difficult to remove from the tank.

In applications where the material in the tank is non-hazardous, the tank would normally be cleaned by personnel entering the tank through an access port, or manway, and manually cleaning the tank. These personnel may utilize suction hoses, hand-held pressure washers, shovels, and other tools, but the process has traditionally been a highly labor intensive endeavor.

One automated technique for cleaning storage tanks utilizes a programmable pressure washer that can be permanently mounted to the tank shell, or inserted through a permanently installed fitting. These systems usually include a rotating washer head that is provided with one or more nozzles that are moved automatically to make the wash head cover a specified area. These pressure washers are normally adapted to be installed in a fixed position relative to the tank with the wash head providing all the movement required.

In general, the tank geometry, including any internal obstructions, and the distribution of deposits make it difficult to match the washing pattern of a single washing head to a specific tank configuration because with the types of washing systems described above, usually some areas are more intensely washed than others. Further, so-called “shadowe” areas that are shielded from the direct impact of the jet by pipe, stanchions, baffles and the like, are not well cleaned. Therefore, many of the systems described above employ several washing heads simultaneously and may operate for extended periods of time, such that excess consumption of washing liquid may occur. This excess consumption of washing liquid represents a poor exploitation of time, an increased energy cost, possibly an undesired wear on the tank interior, and it involves an increased cost of purifying the waste liquid which is discharged in larger quantities than may be necessary. Further, in many cases, access is limited to a manway or other large openings in the tank, and nozzles positioned only at these locations cannot completely clean tanks with shadowed areas.

Thus, there remains a need in the art for methods and apparatus to improve the efficiency of tank washing systems. The embodiments of the present invention are directed to methods and apparatus for adjustably mounting a pressure washing system to any tank that needs to be cleaned, particularly those with internal shadowing elements. The embodiments include a system that can be permanently mounted or that is capable of being transported and put into place without the use of mechanical lifting equipment, thus overcoming the limitations of the prior art.

### SUMMARY OF THE PREFERRED EMBODIMENTS

Provided herein are methods and apparatus for adjustably mounting a pressure washing system to a tank. The preferred embodiments of the present invention are characterized by an attachment mechanism that attaches to a manway on a tank and allows for the adjustable mounting of a pressure washing system.

One embodiment includes a mounting plate adapted to be connected to a tank opening and a pressure washer attachment plate hingably connected to the mounting plate and adapted to receive a pressure washing device. A linear connection apparatus may also be provided to control the relative location between the two plates. The linear connection apparatus may be manually adjusted or controlled by a hydraulic or pneumatic cylinder.

In another embodiment, the attachment mechanism includes a mounting plate adapted to be connected to a tank opening, a second plate hingably connected to the mounting plate, and a pressure washer attachment plate hingably connected to the second plate. The hinged connections may be arranged such as to allow rotation of the wash head about two axes that are substantially perpendicular to each other. Linear connection apparatus may also be provided to control the relative location between the plates. The linear connection apparatus may be manually adjusted or controlled by hydraulic or pneumatic cylinders.

In another embodiment, the attachment mechanism is suited for deploying a pressure washing device from the roof of a tank. The mechanism includes a vertical extension arm that is suspended from a roof-mounted manway. The vertical extension arm supports a primary pivot point about which a first extension arm deploys. A wash head is pivotally mounted to the end of the first extension arm. Alternatively, the wash head may be mounted to a telescoping extension arm that extends from the first extension arm. Pressurized wash fluid is supplied to the wash head through a hydraulic conduit, which may formed from the components of the system or alternatively by a separate conduit.

Thus, the present invention comprises a combination of features and advantages that enable it to substantially increase the efficiency of tank cleaning systems. These and various other characteristics and advantages of the present invention will be readily apparent to those skilled in the art upon reading the following detailed description of the preferred embodiments of the invention and by referring to the accompanying drawings.

### BRIEF DESCRIPTION OF THE DRAWINGS

For a more detailed understanding of the preferred embodiments, reference is made to the accompanying Figures, wherein:

FIGS. 1a and 1b are partial sectional side views representing a pressure washing device disposed in a tank;

FIGS. 2a and 2b are partial sectional top views representing a pressure washing device disposed in a tank;

FIG. 3 is a perspective view of one embodiment of a pressure washing device attachment system;

FIGS. 4a-4d are partial sectional views of a second embodiment of a pressure washing device attachment system.

### DETAILED DESCRIPTION OF THE PREFERRED EMBODIMENTS

In the description that follows, like parts are marked throughout the specification and drawings with the same reference numerals, respectively. The drawing figures are not necessarily to scale. Certain features of the invention may be shown exaggerated in scale or in somewhat schematic form and some details of conventional elements may not be shown in the interest of clarity and conciseness.

The preferred embodiments of the present invention relate to methods and apparatus for adjustably attaching a pressure washing system to a storage tank. The present invention is susceptible to embodiments of different forms. There are shown in the drawings, and herein will be described in detail, specific embodiments of the present invention with the understanding that the present disclosure is to be considered an exemplification of the principles of the invention, and is not intended to limit the invention to that illustrated and described herein.

In particular, various embodiments of the present invention provide a number of different methods and apparatus for attaching a pressure washing system to a storage tank. Reference is made to attaching the pressure washer system to a manway of a storage tank, but the use of the concepts of the present invention is not limited to attachment to a manway and may be attached to any available access point. It is to be fully recognized that the different teachings of the embodiments discussed below may be employed separately or in any suitable combination to produce desired results.

In the discussion that follows the pressure washing device illustrated and discussed may be any available pressure washing system, such as those manufactured by Toftejorg, Inc. Such systems are well known in the art and may be characterized as having a wash head that is preprogrammed to spray pressurized wash fluid over a given area in a predetermined pattern. The wash head and its preprogrammed washing pattern are typically controlled by a control unit, located outside the tank. These systems may be self contained, powered only by the pressurized washing fluid, or may rely on other power, such as hydraulic, pneumatic, or electric, to control and move the wash head.

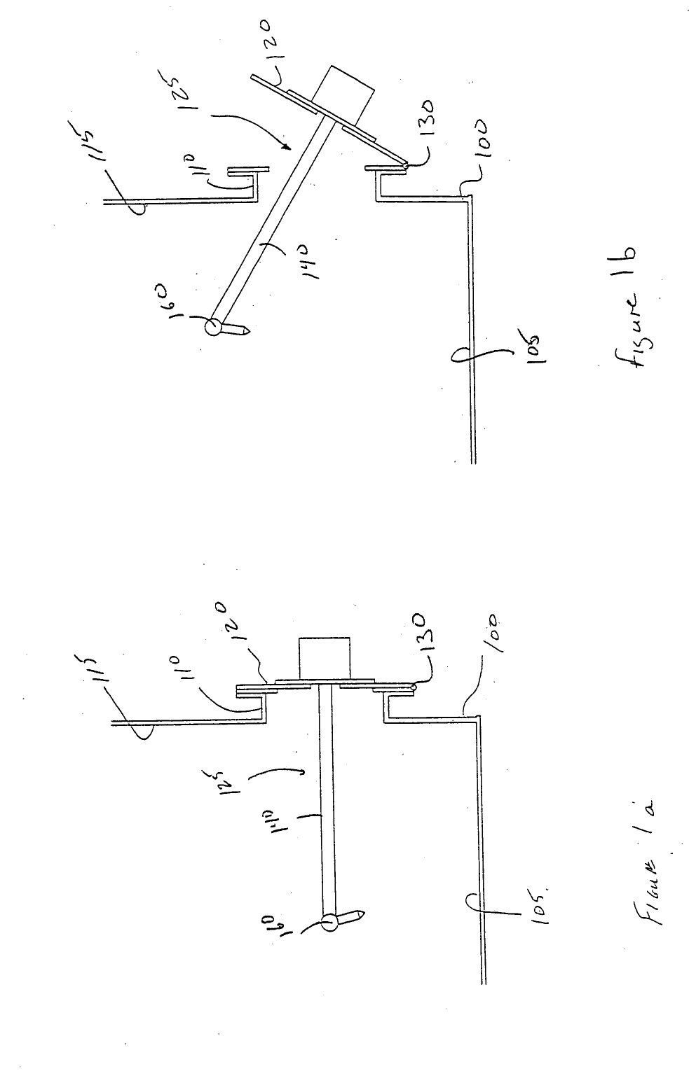

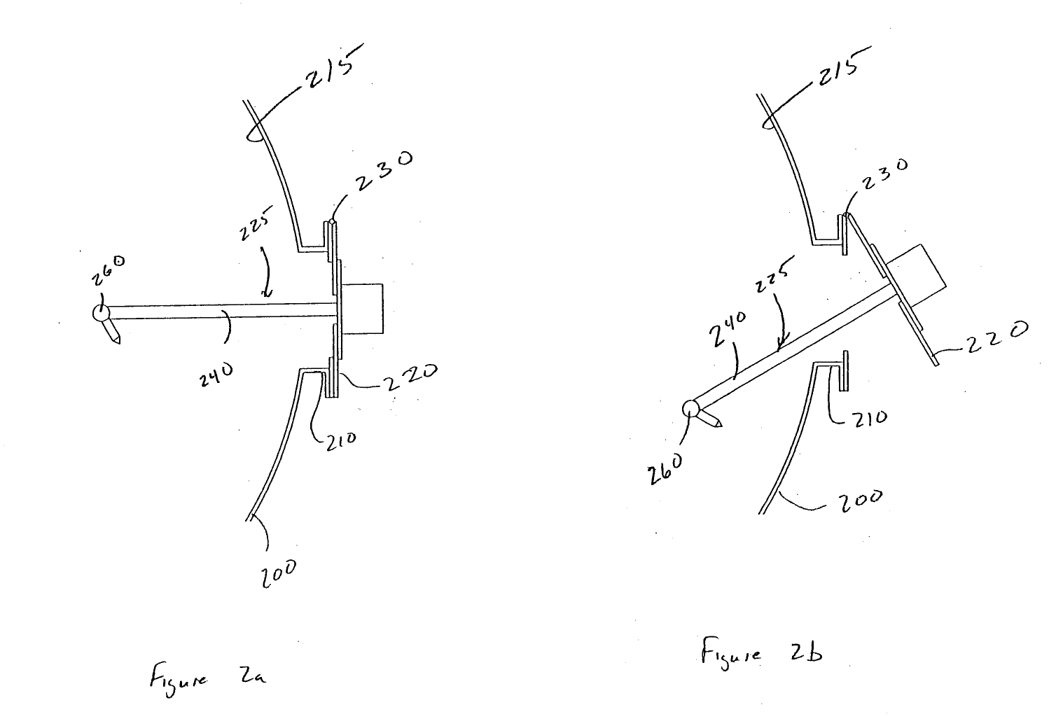

FIGS. 1a and 1b show a partial sectional, side-view of storage tank 100 having manway 110. Attached to manway 110 is a washing device 125 for removing deposits from the floor 105 and interior walls 115 of the tank. Washing device 125 includes wash head 160 that is located at the end of extension arm 140. Washing device 125 is removably affixed to attachment system 120 that allows rotation of device 125 about hinge 130. Hinge 130 is located on the lower edge of system 120 to allow for rotation of device 125 about a substantially horizontal axis. Although not shown in FIGS. 1a and 1b, attachment system 120 may include a adjustment mechanism to control the rotation of device 125 about hinge 130. This connection device may be a linear connection device as shown in, and discussed relative to, FIG. 3 or may be some other type of adjustment device.

In a first position, as shown in FIG. 1a, attachment system 120 maintains extension arm 140 in a substantially horizontal position. In a second position, as shown in FIG. 1b, attachment system 120 enables washing device 125 to be rotated about hinge 130 so that extension arm 140 is at an angle to the horizontal. In the second position, wash head 160 is farther away from tank bottom 105 allowing the head to cover a larger area. Although hinge 130 is shown on the lower edge of attachment system 120 is may also be on the upper edge to allow rotation of washing device 125 to place wash head 160 closer to the tank bottom 105 allowing the wash head to apply wash fluid in a concentrated area.

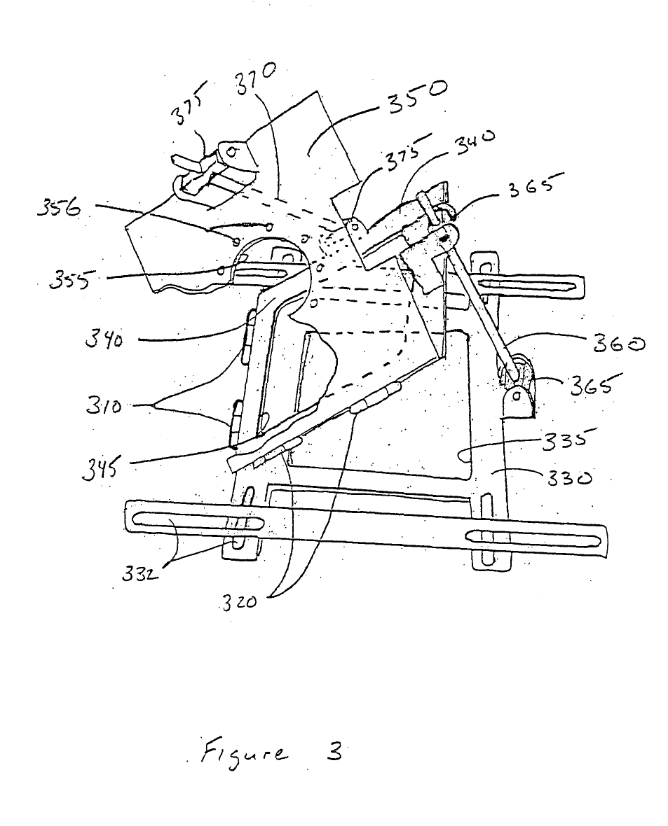

FIGS. 2a and 2b show a partial sectional, top-down view of storage tank 200 having a washing device 225 mounted to manway 210. Washing device 225 includes wash head 260 that is located at the end of extension arm 240 and controlled by a controller, which may be positioned at the other end of extension arm 240. Washing device 225 is removably affixed to attachment system 220 that allows rotation of device 225 about hinge 230. Hinge 230 is located on one side of system 220 to allow for rotation of device 225 about a substantially vertical axis. Although not shown in FIGS. 2a and 2b, attachment system 220 may include a connection device to control the rotation of device 225 about hinge 230. This connection device may be a linear locator as shown in, and discussed relative to, FIG. 3 or may be some other type of adjustment device.

In a first position, as shown in FIG. 2a, attachment system 220 maintains extension arm 240 in a position parallel with the central axis of manway 210. In a second position, as shown in FIG. 2b, attachment system 220 enables washing device 225 to be rotated about hinge 230 so that extension arm 240 is at an angle to the central axis of manway 210. In the second position, wash head 260 is closer to the tank wall 215 allowing a concentrated application of washing fluid by the wash head. Hinge 230 may alternatively be located on the opposite edge of attachment system 220 allowing rotation of washing device 225 in the opposite direction.

FIG. 3 shows an alternative embodiment of an attachment system 300 that includes two sets of hinges 310, 320 that allow for movement of a washing device (not shown) about two substantially perpendicular axes. System 300 includes a manway mounting plate 330, adapted to be connected to a tank wall and hingably attached to a second plate 340 that is hingably attached to a washing device attachment plate 350. The orientation of attachment plate 350 relative to second plate 340 is controlled by linear locator 370, while the relative orientation of second plate 340 to mounting plate 330 is controlled by linear locator 360. Plates 330, 340, and 350 are preferably constructed from steel plate or some other lightweight material that provides desirable strength characteristics but is compact and light enough to be easily portable.

Manway mounting plate 330 includes access hole 335 and a connection point 365 that connects linear locator 360 to the plate. Mounting plate 330 also may include slots 332 that allow the plate to be attached to a range of manway sizes by bolting directly to the manway bolt pattern. Hinges 320 are also attached between mounting plate 330 and second plate 340. Access hole 335 provides clearance for the pressure washing device (not shown) to pass through mounting plate 330.

Second plate 340 includes access hole 345 and connection points 365 and 375 that connect linear locators 360 and 370 to the plate. Second plate 340 also includes hinges 310 that attach to plate 350 and hinges 320 that attach to plate 330. Access hole 345 provides clearance for the pressure washing device (not shown) to pass through second plate 340.

Attachment plate 350 includes access hole 355 and a means for attachment 356, which may be a bolt pattern, for attaching a washing device (not shown). Hinges 310 attach plate 350 to plate 340 and the relative position between the two plates is controlled by linear locator 370.

Linear locators 360 and 370 may be threaded rods that interface with threaded connection points 365 and 375 that are pivotally mounted to plates 330, 340, and 350. Locators 360 and 370 may be designed so that once adjusted to a desired location, the locators are retained in position without intervention from the operator. Locators 360 and 370 alternatively may be hydraulic or pneumatic cylinders that are pivotally attached to plates 330, 340, and 350 and are actuated by a hydraulic or pneumatic power source.

Pressure washing device attachment system 300 may be used by attaching manway mounting plate 330 to a manway, or other access port, on a tank. System 300 is preferably attached using releasable connection members, such as bolts, connected to a bolt pattern on the manway. A pressure washing device is then attached to attachment means 356 so that the extension arm of the device extends through access holes 355, 345, and 335 into the interior of the tank. Washing device may alternatively be connected to attachment system 300 prior to system 300 being attached to the tank. Once system 300 is secured to the tank, linear locators 360, 370 can then be adjusted to place the wash head into the desired position for cleaning. The pressure washing device can then be activated and allowed to clean the tank without intervention from the operator.

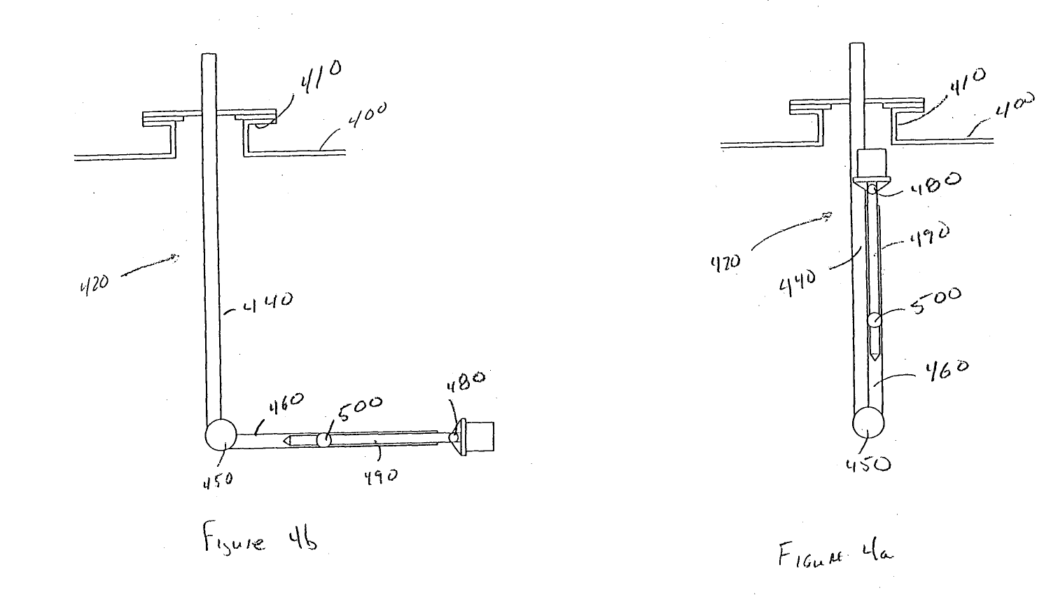

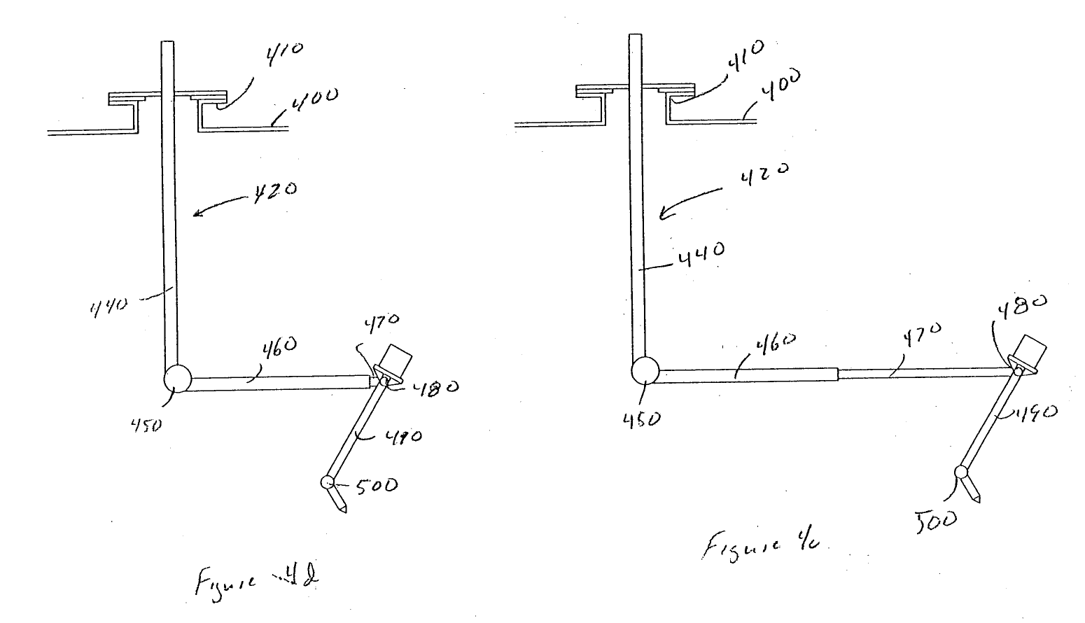

FIGS. 4a-4d depict an alternative pressure washing device attachment system 420 for use in deploying a pressure washing device through a manway 410 in the roof of a tank 400. This embodiment is especially suited for washing the upper regions of the tank and in particular those regions that may have shadowed areas created by structural supports. Attachment system 420 includes a vertical extension arm 440, a primary pivot point 450, a first extension arm 460, a telescoping extension arm 470, a secondary pivot point 480, a wash head arm 490, and wash head 500. Wash head 500 may be a programmable wash head, as described above, or a cleaning tool that provides 360° of coverage without a preprogrammed pattern. Pressurized wash fluid is supplied to wash head 500 through a hydraulic conduit, which may formed from the components of system 420. System 420 is preferably constructed from lightweight tubular members, such as aluminum pipe or tube.

FIG. 4a depicts system 420 in a collapsed position so as to enable easy travel through manway 410. System 420 may be attached to manway 410 by a stationary support, a hinged support, such as that described above, or a rotating support. Once inside the tank, first extension arm 460 is pivoted about primary pivot point 450 to its desired deployment position, as shown in FIG. 4b. This position may be any angle relative to vertical extension arm 440. The pivoting and the deployment angle of arm 460 may be controlled by cables and pulleys operated from outside the tank or by a hydraulic control mechanism.

Once the first extension arm 460 is in the desired position, telescoping extension arm 470 can be extended from its stored position inside of arm 460 to an extended position, as shown in FIG. 4c. This deployment may be controlled by a gear or chain drive operated from the surface or by a hydraulic control mechanism. Once arm 470 has been deployed, wash head arm 490 can be rotated about secondary pivot point 480 to position wash head 500 in the desired location for washing. Secondary pivot point 480, coupled with the range of motion of wash head 500, provide full coverage in any direction from wash head 500. The rotation of wash head arm 490 may be manually or hydraulically controlled from outside the tank.

Alternatively, wash head arm 490 can be rotated about secondary pivot point 480 to position wash head 500 in the desired location for washing without extending arm 470, as shown in FIG. 4d. Likewise, any subset and combination of components from system 420 may be used during any deployment of the system to position wash head 500 in the desired location. System 420 may be removed from the tank by reversing the deployment process.

Thus, the above described embodiments provide a pressure washing device attachment system that is lightweight and easy to install. The preferred system can be transported and installed into a tank by a single operator. The preferred system also needs no external power source to locate the wash head in a desired area and only requires a source of pressurized fluid supplied to the pressure washing device. The preferred system also provides for adjusting the location of the wash head in at least two directions without detaching from the manway. Furthermore, the preferred system can enable the entire area that is desired to be cleaned to be effectively and efficiently cleaned.

The embodiments set forth herein are merely illustrative and do not limit the scope of the invention or the details therein. It will be appreciated that many other modifications and improvements to the disclosure herein may be made without departing from the scope of the invention or the inventive concepts herein disclosed. Because many varying and different embodiments may be made within the scope of the inventive concept herein taught, including equivalent structures or materials hereafter thought of, and because many modifications may be made in the embodiments herein detailed in accordance with the descriptive requirements of the law, it is to be understood that the details herein are to be interpreted as illustrative and not in a limiting sense.

1. A system for cleaning an enclosed space comprising:
a mounting plate adapted to be connected to an opening into the enclosed space;
an attachment plate hingably connected to said mounting plate; and
a washing device attached to said attachment plate and extending into the enclosed space.

2. The system of claim 1 further comprising a linear connection device adapted to control the position of said attachment plate relative to said mounting plate.

3. The system of claim 2 wherein said linear connection device is manually controlled.

4. The system of claim 2 wherein said linear connection device is controlled by a hydraulic or pneumatic cylinder.

5. The system of claim 1 wherein said washing device is adapted to clean shadowed areas within the enclosed space.

6. The system of claim 1 wherein the system is adapted to be easily transported between two openings.

7. The system of claim 1 wherein said washing device comprises:
a wash head adapted to disperse washing fluid onto a cleaning area;
an extension arm having a first end at which said wash head is attached; and
a controller attached to a second end of said extension arm and adapted to supply washing fluid and control signals to said wash head.

8. The system of claim 7 wherein said washing device is mounted such that said controller is outside the cleaning area and said wash head is inside the cleaning area.

9. A pressure washer mounting system comprising:
a mounting plate adapted to attach to an opening in a tank;
a second plate connected to said mounting plate by a first hinge;
an attachment plate connected to said second plate by a second hinge, wherein said attachment plate is adapted to receive a pressure washer.

10. The system of claim 9 wherein the first hinge is perpendicular to the second hinge.

11. The system of claim 9 further comprising a first linear connection apparatus adapted to control the relative position of said second plate relative to said mounting plate.

12. The system of claim 11 further comprising a second linear connection apparatus adapted to control the relative position of said attachment plate relative to said second plate.

13. The system of claim 12 wherein said first and second linear connection apparatus are adapted to move said attachment plate about two axes.

14. The system of claim 13 wherein the two axes are coincident to the first and second hinges.

15. The system of claim 9 wherein the pressure washer attaches to said attachment plate and extends through said second plate and said mounting plate and into the tank interior.

16. The system of claim 15 wherein said pressure washer comprises:
a controller adapted to attach to said mounting plate;
an extension arm extending from said controller into the interior of the tank; and
a wash head connected to said extension arm and adapted to disperse washing fluid into the tank, wherein said wash head is also adapted to receive washing fluid and control signals from said controller.

17. A method for cleaning an enclosed space, the method comprising:
attaching a mounting plate to an opening in the enclosed space;
attaching a washing device to an attachment plate hingably connected to the mounting plate, wherein a portion of the pressure washer extends into the tank.

18. The method of claim 17 further comprising relocating the washing device by adjusting the position of the attachment plate relative to the mounting plate.

19. The method of claim 18 wherein the washing is relocated by adjusting a linear connecting device that connects the mounting plate and the attachment plate.

20. A pressure washer apparatus comprising:
a mounting assembly adapted to connect the pressure washing apparatus to an opening in the roof of a tank;
a first arm extending from said mounting assembly into the tank;
a second arm pivotally connected to said first arm; and
a washing device mounted to said second arm and adapted to disperse a cleaning fluid into the tank.

21. The apparatus of claim 20 wherein said washing device further comprises:
a third arm rotatably connected to said second arm;
a wash head disposed at one end of said third arm.

22. The apparatus of claim 20 wherein said second arm is a telescoping arm.

23. The apparatus of claim 20 wherein the cleaning fluid is supplied through fluid conduits formed by one or more of the arms.

24. The apparatus of claim 20 wherein said washing device is adapted to clean shadowed areas within the tank.

25. The apparatus of claim 20 wherein the apparatus is adapted to be easily transported between two openings.
